(19) United States
(12) Patent Application Publication
(10) Pub. No.: US 2015/0142565 A1
(43) Pub. Date: May 21, 2015

(54) Targeting Content Based On Local Queries

(71) Applicants: Xuefu Wang, Los Altos, CA (US); Julia Lennerz, Kilchberg (CH); Xinyu Tang, Cupertino, CA (US); Shalini Agarwal, San Francisco, CA (US)

(72) Inventors: Xuefu Wang, Los Altos, CA (US); Julia Lennerz, Kilchberg (CH); Xinyu Tang, Cupertino, CA (US); Shalini Agarwal, San Francisco, CA (US)

(21) Appl. No.: 13/273,909

(22) Filed: Oct. 14, 2011

(51) Int. Cl. G06Q 30/02

(52) U.S. Cl. CPC G06Q 30/0261; G06Q 30/0256
USPC 705/14.54; 705/14.58

(57) ABSTRACT

Methods, systems, and apparatus, including computer programs encoded on a computer-readable storage medium, and including a method for determining content based on a location. The method comprises: receiving a query; determining the query is a local query including determining a location associated with the query; when the query is a local query, determining one or more categories associated with the query; and using the query, the location, and the one or more categories to determine content responsive to the query.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors through an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for determining content based on a location. The method comprises: receiving a query; determining the query is a local query including determining a location associated with the query; when the query is a local query, determining one or more categories associated with the query; and using the query, the location, and the one or more categories to determine content responsive to the query.

These and other implementations can each optionally include one or more of the following features. Receiving the query can include receiving a query request. Determining the query is a local query can include determining if the query includes location information, and determining the location associated with the query can include using the location information to determine the location. The location information can include location information from a map-related application. The location information from a map-related application can include location information from a current viewport. The location information can include location information determined from keywords of the query. Determining the query is a local query can include determining a location of a user that submitted the query comprising: determining an IP address of where the query originated and determining a location based on the IP address. Determining one or more categories can include determining categories for local searches in the location. Determining the one or more categories can include determining a category associated with a business that supplied a prior local advertisement in response to the query. The method can further comprise: storing an association between a query, location data and one or more categories, where determining a category can include evaluating stored query location data to determine one or more associated categories for a given query location pair. Using the query, the location, and the one or more categories to determine content responsive to the query further can include using a query language and a display language.

In general, another innovative aspect of the subject matter described in this specification can be implemented in methods that include a method for targeting content using location-based categories. The method comprises: associating one or more categories with a query-location pair, where the query-location pair includes a query and a location of a device from which the query was submitted; and targeting, to users that submit the query, content based on the query and the one or more categories.

In general, another innovative aspect of the subject matter described in this specification can be implemented in systems that include a content management system that provides content responsive to received requests comprising: a query handler that is enabled to receive a query and location information and provide content in response to the query and the location information; a location engine that is enabled to determine that the query is a local query; and a category engine that is enabled to determine one or more categories associated with the query if it is a local query.

These and other implementations can each optionally include one or more of the following features. The content management system can further include a ranking engine enabled to rank content using at least the location information.

In general, another innovative aspect of the subject matter described in this specification can be implemented in a computer program product tangibly embodied in a computer-readable storage device and comprising instructions that, when executed by a processor, perform a method for providing content, the method comprising: receiving a query; determining the query is a local query including determining a location associated with the query; when the query is a local query, determining one or more categories associated with the query; and using the query, the location, and the one or more categories to determine content responsive to the query.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for targeting content based on local queries.

FIG. 2 is a block diagram showing an example system for targeting content based on local queries.

FIG. 3 is a flowchart of an example process for targeting content based on local queries.

FIG. 4 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for targeting content based on local queries. A query can be a local query because, for example, location information is associated with the query and can be used with the query to determine content based on the geographic location. As an example, a user in San Francisco with a mobile device may enter the name of a business entity, such as a local restaurant, as a search query in a browser, resulting in a query associated with the local restaurant. In another example, the user may be running a map-related application and enter the name of the local restaurant, such as to obtain driving directions to the local restaurant, resulting in a query request associated with the local restaurant. In some cases, the name of the restaurant (e.g., “ChezBurrito”) may be obscure so that few, if any, content items (e.g., ads) are targeted using keywords based on the restaurant's name. In some implementations, categories associated with the entity can be looked up, such as categories of Mexican food and take-out for ChezBurrito. Using the category names (e.g., as additional keywords), location information and any available keywords, content items can be determined that are responsive to the query (or query request). In this way, an expanded number of content items can be matched and served as compared to using keywords alone.

The local query can be associated with the user's current location or a location-of-interest for the user. For example, a user with a mobile computing device may be in San Francisco, and the user's current location (e.g., a latitude/longitude) can be determined from GPS capabilities of the user's mobile device. In another example, the user may be in a different location running an application using and/or displaying information associated with San Francisco. A map application may, for example, display a map of San Francisco, accept input from the user specifying a San Francisco address as a starting point or destination, or display driving directions to a San Francisco address. In these examples, the location can be determined from coordinates of a map viewport and/or from a specified (or displayed) address or geographic location. In other examples, a user-provided base address or the IP address of the user's device can be used to determine the location.

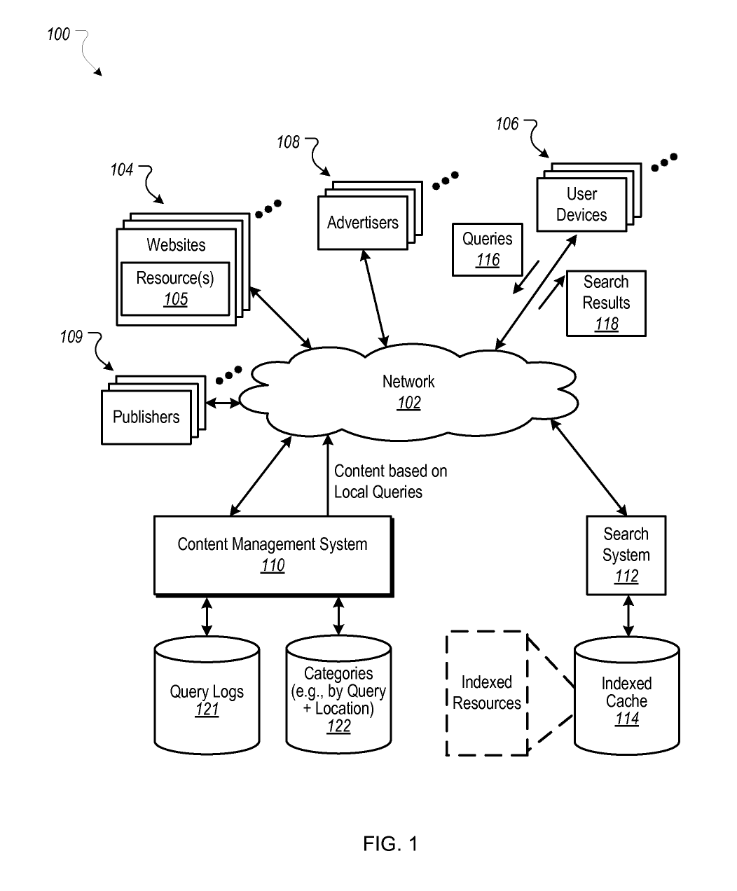

FIG. 1 is a block diagram of an example environment 100 for targeting content based on local queries. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content providers (e.g., advertisers 108), publishers 109, and the content management system 110. The example environment 100 may include many thousands of websites 104, user devices 106, advertisers 108 and publishers 109.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management system 110 can generate search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some examples, requests for content other than, or in addition to, search queries 116 can occur, such as requests for content based on a location, as is described in this document. In these examples, no search terms are explicitly provided by the user, but keywords for which to target content items can be inferred from the location associated with the request for content (e.g., the query) as is described further below.

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116. In some implementations, keywords can be inferred from a location, such as based on the user's current geographic location and/or a location-of-interest for the user.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. However, in applications in which search queries 116 are not used, the content management system 110 can use other ways of selecting content, e.g., in the absence of keywords obtained from search queries 116. For example, as described within this document, the content management system 110 can select content using keywords inferred from the user's current location and the names of categories associated with entities in and around the location.

The content management system 110 can select from the eligible content items that are to be provided for presentation in slots of a resource or search results page based at least in part on results of an auction. For example, for the eligible content items, the content management system 110 can receive bids from content sponsors (e.g., advertisers) and allocate the slots, based at least in part on the received bids (e.g., based on the highest bidders at the conclusion of the auction). The bids are amounts that the content sponsors are willing to pay for presentation (or selection) of their content with a resource or search results page. For example, a bid can specify an amount that a content sponsor is willing to pay for each 1000 impressions (i.e., presentations) of the content item, referred to as a CPM bid. Alternatively, the bid can specify an amount that the content sponsor is willing to pay for a selection (i.e., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by an advertiser to be any measurable/observable user action, such as downloading a white paper, navigating to at least a given depth of a website, viewing at least a certain number of web pages, spending at least a predetermined amount of time on a web site or web page, registering on a website, experiencing media, or performing a social action regarding a content item (e.g., an ad), such as republishing or sharing the content item. Other actions that constitute a conversion can also be used.

In some implementations, the likelihood that a conversion will occur can be improved, such as by serving content that is more likely to be of interest to the user. For example, if a content item that is served is selected in part based on the user's current location and category names associated with the query terms, then the user may be more likely to interact with the content item because it includes content that is more relevant to the user. In some implementations, the categories can be based on past queries.

Query logs 121 can include information about the past queries, e.g., including all queries entered by a single user, a group of users or an entire community of users. For example, information stored for each query can include the one or more query terms, the location associated with the query, the query language and display language, and the content items delivered in response to the query. One example location associated with the query is the location-of-interest that can be determined from viewport coordinates of a user's map-related application when the query request occurred. Another example location is the location of the device from which the query was submitted, e.g., determined using GPS capabilities of the device. In some implementations, information for the content items can include the URL(s) of resource(s) (e.g., web pages) that were responsive to the user's query. In some implementations, query logs 121 can logically include cookies stored on the user device 106 that can contain information regarding the user's most recent Internet activity.

In some implementations, information in the query logs 121 can be analyzed to determine categories associated with groups of queries (e.g., by query and location), and this information can be stored in a categories data store 122. In some implementations, the content management system 110 can obtain category information from the landing pages of the content items (e.g., search results) responsive to the past queries. As an example, the content items can correspond to businesses or other entities that supplied a prior local advertisement in response to the query. In some implementations, determining which content items were responsive to a query can use a query fingerprint such as (query terms+user's location-of-interest). In some implementations, the query fingerprint can include language, such as (query terms+user's location-of-interest+user's query language+user's display language). From this information, categories determined from the responsive content items of past similar queries, for example, can be used to determine keywords for targeting content when new queries are received that have a similar query fingerprint. In an example, the landing pages for query X and location Y can be analyzed to extract names of categories (e.g., “restaurants”, “Mexican restaurants,” etc.) from all of the queries that were entered for location Y. In some implementations, weights can be assigned to categories for a query-location pair based on various factors, such as the number of queries for that category. Categories having lower weights relative to the other categories can be discarded. In some implementations, the categories that are kept can be stored in the categories data store 122.

For situations in which the systems discussed here collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that the no personally identifiable information can be determined for the user, or a user's geographic location may be generalized where location information is obtained (such as to a city, ZIP code, or state level), so that a particular location of a user cannot be determined. In some implementations, opt out features related to social networking systems, for example, can allow the user to specify that the user's activity stream content is not to be used in ads, or to anonymize the information in some way.

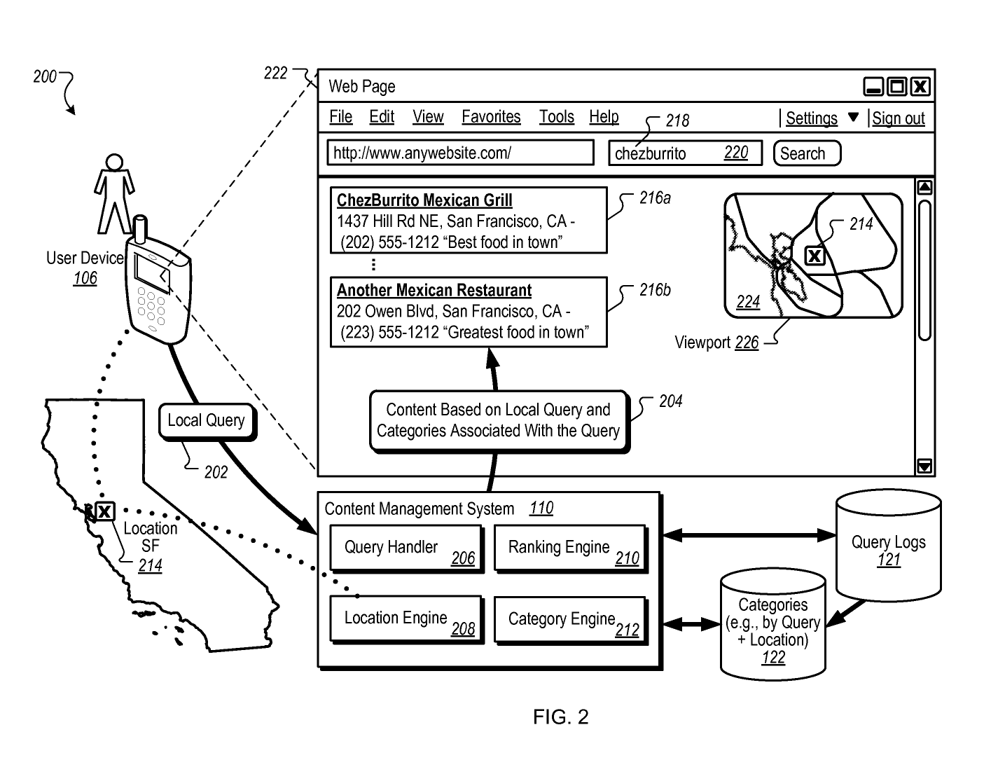

FIG. 2 is a block diagram showing an example system 200 for targeting content based on local queries. As an example, the content management system 110 can receive a query 202, such as from a user device 106, and in response, provide content items 204. The content items 204 provided can be targeted based, at least in part, on location information associated with the query, e.g., a geographic location associated with the query 202 (e.g., the current location of the user, or a location-of-interest).

The content management system 110 can include plural engines, including a query handler 206, a location engine 208, a ranking engine 210, and a category engine 212. The query handler 206 can receive queries 202 and provide content 204 in response to the queries. The query handler 206 can also store information about queries (e.g., in the query logs 121) such as the query terms, the location-of-interest associated with the query, the query and display languages, and the content items delivered in response to the query. The location engine 208 can be used to determine a location 214 associated with the query 202, such as the user's current location or a location-of-interest. The location engine 208 can also determine entities, such as businesses, stores, restaurants, etc. for the geographic location. The ranking engine 210 can be used to rank elements used within the content management system 110. In some implementations, the ranking engine 210 can rank categories based on the number of queries that have been received and that are associated with the category. In some implementations, the ranking engine 210 can rank content items based, at least in part, on location information. For example, the ranking engine 210 can rank the ads responsive to the query 202 based on the distance that the advertised entities are from the location associated with the query. The category engine 212 can be used to determine categories, such as by looking up categories (e.g., from the categories data store 122) for a given query-location pair. In some implementations, the category engine 212 can generate information to be stored in the categories data store 122 by analyzing information in the query logs 121. In some implementations, the category engine 212 can be used to determine categories associated with entities (e.g., stores, businesses, etc.) in the geographic area of the location 214.

In some implementations, the query handler 206 and plural engines 208-212 can operate as a local search engine that, in combination with the search system 112 (described earlier with reference to FIG. 1), can generate targeting keywords based on location information of local queries. In some implementations, the keywords can include the names of categories that are stored for query-location pairs in the categories data store 122. The targeting keywords can be used to target resources, e.g., selected from a set of eligible content items (e.g., business listings), and to provide content items 204 that are responsive to the query 202. Content items 204 can be rendered in plural content item slots 216a and 216b which can include, for example, ad slots for displaying ads as well as slots for displaying content items that are not ads (e.g., non-ad content for web pages, etc.).

Upon receiving the query 202, the content management system 110 can determine whether the query is a local query, including determining a location associated with the query. Local queries, by way of example, can comprise queries (or query requests) that include location information. Example location information includes one or more terms in the query that identify the location, a location determined from the current location of the user device 106, or a location-of-interest associated with the query. Queries, for example, can include search queries, such as a search query 218 “chezburrito” that the user can enter in a search field 220 on a web page 222. Query requests, for example, can include requests for content that do not necessarily include queries or query terms, but may be provided by location-based applications, such as map-related applications that display a map (e.g., a map 224 displayed in a viewport 226). In this example, the map 224 displays the location 214, e.g., a place in San Francisco from which the query 202 originated or the location for which the query 202 is associated.

In some implementations, the content management system 110 can use location information associated with the query 202 (e.g., a local query) to determine the location (e.g., the location 214 in the San Francisco area) associated with the query 202. In some implementations, the query 202 can include keywords that the content management system 110 can use, for example, as location information to determine a location. For example, the user's search query 218 “chezburrito” can be the name of a local Mexican restaurant, or the user may enter address or phone number information in the query search 218 that can be used to identify the ChezBurrito restaurant using reverse business look-up techniques.

In one example of determining a location from a map-related application, the query 202 can be based on a location associated with a location-related application running on the user device 106, e.g., displaying the map 224 of a San Francisco area in the viewport 226. Example location-related applications include map applications (e.g., applications for displaying maps and/or requesting and receiving driving directions, etc.) and street view applications (e.g., applications that provide a panoramic view of an area). Other example location-related applications include any applications in which a location can be inferred from data provided by, or displayed to, the user.

In some implementations, the location engine 208 can determine the location 214 from the user's user device 106, e.g., using global positioning system (GPS) capabilities of the user device 106, or obtained through cell triangulation, e.g., from three or more signal transmitters, towers or satellites that serve the user device 106. In some implementations, the location of the user device 106 can be obtained through periodic mobile check-ins, such as positional checkpoints made by the mobile device at regular intervals. In some implementations, the location 214 can be determined from geographic information displayed in, or related to, a viewport 226. For example, a map application (or street view application) that is running on the user device 106 can display the map 224 (or street view) of an area in San Francisco within the viewport 226. Then, the location engine 208 can infer the location 214 from, for example, the center-point coordinates of the map's viewport, the field-of-view direction of the street view, or from some other source. In some implementations, the location 214 can be determined from place names (e.g., city names, state names, street names, ZIP codes, etc.) that the user enters into the map application or that can be determined from driving directions provided by the map application. Other ways of determining the location 214 associated with the query 202 can be used.

When the query is a local query, one or more categories associated with the query can be determined. In some implementations, the category engine 212 can determine categories (e.g., restaurants, Mexican food, take-out, etc.) based on terms of the search query 218 (e.g., “chezburrito”) and the location 214. For example, the category engine 212 can look up the categories in the categories data store 122, such as by using query-location pairs from terms of the search query 218 plus the location 214. In this way, categories can be determined for the current query 202 and the location 214 based on categories associated with past local searches that are stored in the categories data store 122. In some implementations, categories can be category phrases comprising two or more terms (e.g., “Mexican food”).

In some implementations, the category engine 212 can determine categories based on entities (e.g., stores, businesses, etc.) that exist in the area around the location 214. For example, in situations when a query request is received without query terms, but location information is provided, categories can be determined. In some implementations, the location engine 208 can identify the names of the entities (e.g., the restaurants “Chez Burrito,” “Inventive Tacos,” etc.) in the area of the location 214 that is associated with the user's query 202. Then, the category engine 212 can use the entity names plus the location 214 to look up the categories from the categories data store 122. In some implementations, the category engine 212 can access all categories in the categories data store 122, regardless of query, and select the categories, for example, that have the highest number of previous queries.

The content management system 110 can target and provide content items 204 using available search terms from the query 202 as well as keywords that are based on the location 214 and categories of entities in the location 214. For example, in response to the user entering “chezburrito” as the search query 218, the content management system 110 can return content items 204 that include ads for the ChezBurrito Mexican Grill and another Mexican restaurant that can be rendered in ad slots 216a and 216b, respectively.

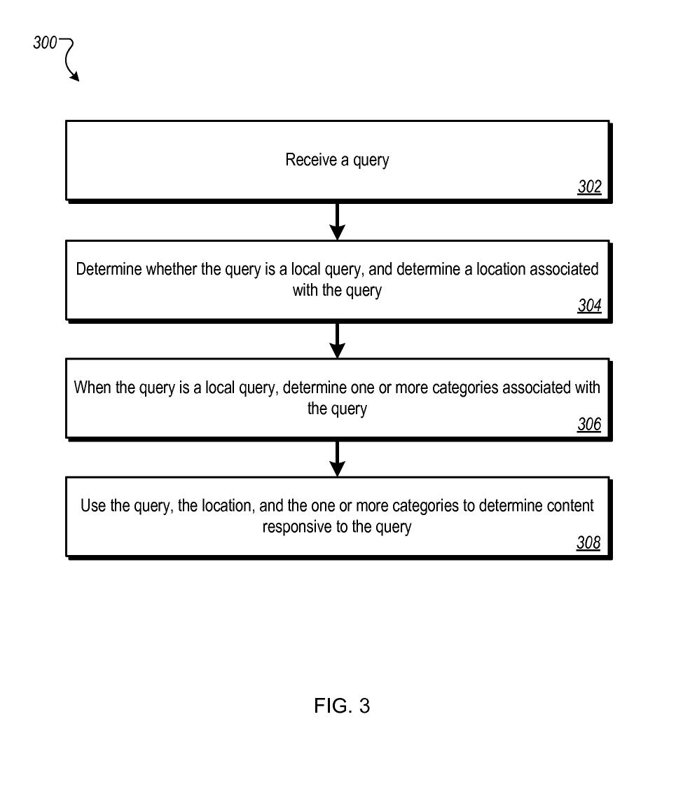

FIG. 3 is a flowchart of an example process 300 for targeting content based on local queries. The process 300 can be performed, for example, by the content management system 110 including the query handler 206, the location engine 208, the ranking engine 210, and the category engine 212. FIG. 2 is used to provide examples for steps of the process 300.

A query is received (302). As an example, the content management system 110 can receive a query 202 from the user device 106. The query 202 can be the search query 218 entered in the search field 220 and/or the query 202 can include location information for the location 214 (e.g., San Francisco) associated with the query 202.

A determination is made whether the query is a local query, including determining a location associated with the query (304). For example, the location engine 208 can determine if the query 202 is local, such as if the query includes location information that can be used to target content for a local entity associated with the location 214 (e.g., a San Francisco restaurant).

When the query is a local query, one or more categories associated with the query are determined (306). As an example, the category engine 212 can determine one or more categories (e.g., Mexican restaurants, take-out, etc.) associated with the query 202. The categories can be based, for example on categories corresponding to entities associated with the query 202, such as by accessing category information in the categories data store 122.

Using the query, the location, and the one or more categories, content responsive to the query is determined (308). For example, the content management system 110, and in particular the query handler 208, can determine content (e.g., ads related to Mexican restaurants) responsive to the query 202.

In some implementations, the content items can be ranked using at least the location information. The ranking engine 210, for example, can rank the ads responsive to the query 202 based on the distance that the advertised entities are from the location 214. For example, if the content management system 110 identifies four content items that are responsive to the query 202, the ranking engine 210 can rank the content items closest-to-farthest. As a result of the ranking, for example, the ads for ChezBurrito Mexican Grill and the other Mexican restaurant can be selected and rendered in ad slots 216a and 216b, respectively.

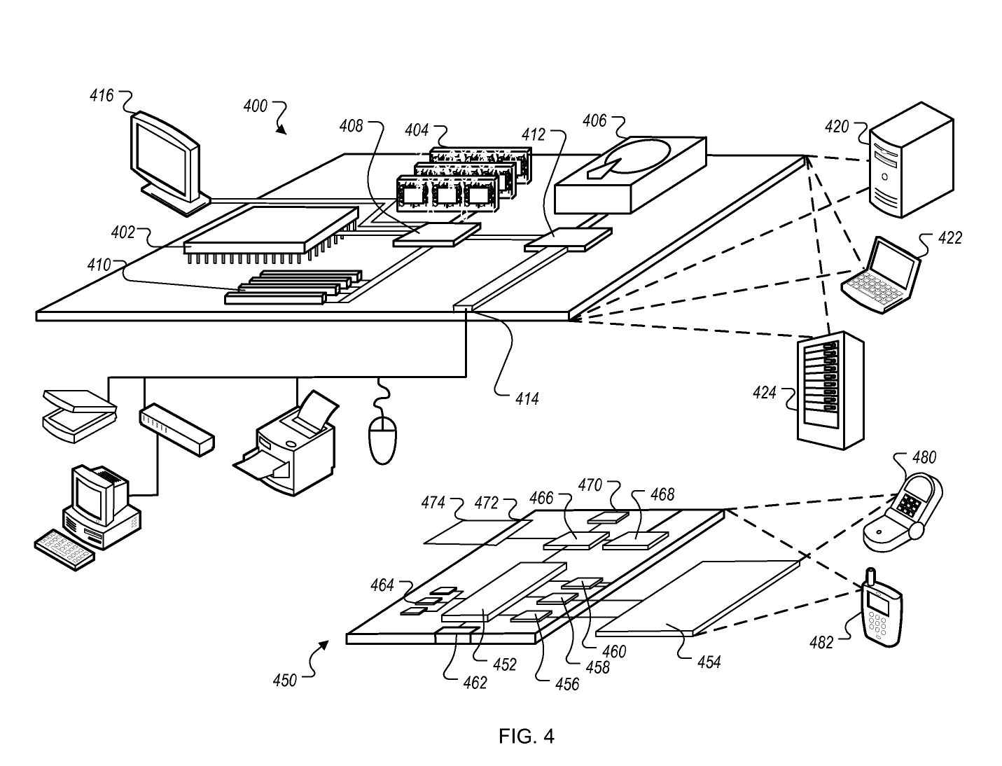

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, using one or more processors, a query comprising one or more terms, the query corresponding to a request for search results associated with the one or more terms;
determining, using the one or more processors, whether the query includes an identification of an entity, and whether the query is a local query in which a location is associated with the query;
if the query includes the identification of the entity and is a local query, determining, using the one or more processors, one or more categories associated with the identification of the entity and the local query;
determining, using the one or more processors, at least one characteristic of one or more ad slots defined for a search results page associated with displaying the requested search results, the at least one characteristic corresponding to at least one of a size of the one or more ad slots or a media type available for presentation within the one or more ad slots;
selecting, using the one or more processors, one or more advertisements responsive to the query based on the local query, the location, the one or more determined categories and the at least one characteristic of the one or more ad slots,
wherein determining the one or more categories comprises determining at least one category associated with a business that supplied a prior local advertisement in response to a previous query comprising the same one or more terms as the received query.

2. (canceled)

3. The method of claim 1, wherein
determining whether the query is a local query includes determining if the query includes location information, the method further comprising
determining the location associated with the query based on the location information.

4. The method of claim 3, wherein the location information includes location information from a map-related application.

5. The method of claim 4, wherein the location information from a map-related application includes location information from a current viewport.

6. The method of claim 3, wherein the location information includes location information determined from keywords of the query.

7. The method of claim 1, wherein determining the query is a local query includes determining a user location of a user submitting the query, the method further comprising:
determining an IP address associated with an origin of the query or the user location; and
determining the location based on the IP address or the user location.

8. The method of claim 1, wherein determining one or more categories includes determining categories for local searches in the location.

9. (canceled)

10. The method of claim 1, further comprising storing an association between query location data and the one or more categories,
wherein determining one or more categories includes evaluating the stored association to determine one or more associated categories for a given query-location pair.

11. The method of claim 1, wherein determining content responsive to the query based on the local query, the location, the one or more categories and the at least one characteristic of the one or more ad slots includes using a query language and a display language.

12. A method comprising:
associating, using one or more processors, one or more categories with a query-location pair, wherein the query-location pair includes a query corresponding to a request for search results and a location of a device from which the query was submitted, the query comprising one or more terms and being associated with an identification of an entity;
determining, using the one or more processors, at least one characteristic of one or more ad slots defined for a search results page associated with displaying the requested search results, the at least one characteristic corresponding to at least one of a size of the one or more ad slots or a media type available for presentation within the one or more ad slots;
selecting, using the one or more processors, one or more advertisements responsive to a user submitting the query based on the query, the identification of the entity, the one or more categories and the at least one characteristic of the one or more ad slots,
wherein at least one of the one or more categories is determined by being associated with a business that supplied a prior local advertisement in response to a previous query comprising the same one or more terms as the query.

13. The method of claim 12, further comprising:
determining if the query includes location information; and
if the query includes location information, determining the location from the location information.

14. The method of claim 12, further comprising:
determining the one or more categories for local searches in the location.

15. (canceled)

16. (canceled)

17. (canceled)

18. A non-transitory machine-readable medium comprising instructions stored therein, which when executed by one or more processors, cause the one or more processors to perform operations comprising:
receiving a query comprising one or more terms;
determining whether the query includes an identification of an entity, and whether the query is a local query in which a location is associated with the query;
if the query includes the identification of the entity and is a local query, determining one or more categories associated with the identification of the entity and the local query;
ranking a plurality of advertisements based on a distance that advertised entities associated with the plurality of advertisements are located relative tQ the location associated with the query;
selecting one or more advertisements of the plurality of ranked advertisements responsive to the query based on the local query, the one or more categories and the location-based ranking assigned to each advertisement,
wherein determining the one or more categories comprises determining at least one category associated with a business that supplied a prior local advertisement in response to a previous query comprising the same one or more terms of the received query.

19. The non-transitory machine-readable medium of claim 18, wherein determining whether the query is a local query includes determining if the query includes location information, the operations further comprising:
determining the location associated with the query based on the location information.

20. (canceled)

21. The method of claim 1, further comprising assigning, using the one or more processors, a weight to each of the one or more determined categories, wherein the weight assigned to each of the one or more determined categories is determined based on a number of queries associated with each of the one or more determined categories.

22. (canceled)

23. (canceled)

24. The method of claim 1, further comprising providing for display, using the one or more processors, the requested search results within the search results page along with the one or more selected advertisements within the one or more ad slots.

25. The method of claim 1, further comprising ranking, using the one or more processors, a plurality of advertisements based on a distance that advertised entities associated with the plurality of advertisements are located relative to the location associated with the query, wherein selecting the one or more advertisements comprises selecting one or more advertisements from the plurality of ranked advertisements responsive to the query based on the local query, the ranking assigned to each advertisement, the one or more determined categories and the at least one characteristic of the one or more ad slots.

26. The method of claim 12, further comprising providing for display, using the one or more processors, the requested search results within the search results page along with the one or more selected advertisements within the one or more ad slots.

27. The method of claim 12, further comprising ranking, using the one or more processors, a plurality of advertisements based on a distance that advertised entities associated with the plurality of advertisements are located relative to the location associated with the query, wherein selecting the one or more advertisements comprises selecting one or more advertisements from the plurality of ranked advertisements responsive to the query based on the local query, the ranking assigned to each advertisement, the one or more determined categories and the at least one characteristic of the one or more ad slots.

28. The non-transitory machine-readable medium of claim 18, wherein the query corresponds to a request for search results associated with the one or more terms, further comprising determining at least one characteristic of one or more ad slots defined for a search results page associated with displaying the requested search results, the at least one characteristic corresponding to at least one of a size of the one or more ad slots or a media type available for presentation within the one or more ad slots.
